(19) United States
(12) Patent Application Publication
(10) Pub. No.: US 2026/0166799 A1
(43) Pub. Date: Jun. 18, 2026

(54) Optical Film

(71) Applicant: 3M INNOVATIVE PROPERTIES COMPANY, St. Paul, MN (US)

(72) Inventors: Samuel A. Minno, St. Paul, MN (US); William T. Fay, Woodbury, MN (US); Stephen A. Johnson, Woodbury, MN (US); Lin Zhao, Woodbury, MN (US); John A. Wheatley, Stillwater, MN (US); Raghunath Padiyath, Woodbury, MN (US)

(21) Appl. No.: 19/119,873

(22) PCT Filed: Oct. 11, 2023
(86) PCT No.: PCT/IB2023/060196

§ 371 Date: Apr. 10, 2025

Related U.S. Application Data
(60) Provisional application No. 63/380,806, filed on Oct. 25, 2022.

(51) Int. Cl. B29C 48/21; G02B 5/28; G02B 5/30

(52) U.S. Cl. CPC B29C 48/21; G02B 5/282; G02B 5/305; B29C 2948/92152; B29C 2948/92638; B29C 2948/92742

(57) ABSTRACT

An optical film includes a plurality of polymeric layers disposed between, and coextruded with, first and second skin layers. The optical film includes non-overlapping substantially parallel first and second regions extending along a length, and arranged along a width, of the optical film. Each of the polymeric layers and the first and second skin layers extend seamlessly and continuously between and across the first and second regions. Each of the polymeric layers has average thicknesses h1 and h2 in the respective first and second regions, where h1 greater than h2 by at least about 5%. Average separations between outermost first major surfaces of the first and second skin layers are s1 and s2 in the respective first and second regions, where s1 and s2 are within less than about 5% of each other. An optical sensing system includes a windshield including the optical film.

### TECHNICAL FIELD

The present description relates generally to optical films.

### BACKGROUND

An optical film can substantially transmit light in a visible wavelength range and substantially reflect light in a near infrared wavelength range.

### SUMMARY

In some aspects, the present description provides a multilayer optical film having different transmission spectra in different regions across a width of the optical film. Each layer of the optical film can extend seamlessly and continuously across the width and a length of the optical film. The optical film can have a substantially uniform total thickness. The optical film can be used in optical constructions, windshields, and/or optical sensing systems, for example.

In some aspects, the present description provides an optical film including a plurality of polymeric layers disposed between, and coextruded with, first and second skin layers. Each of the polymeric layers can have a maximum thickness of less than about 700 nm. Each of the first and second skin layers can have a maximum thickness of greater than about 500 nm. The optical film includes non-overlapping substantially parallel first and second regions extending along a length, and arranged along a width, of the optical film. Each of the polymeric layers and the first and second skin layers extend seamlessly and continuously between and across the first and second regions. Each of the polymeric layers has average thicknesses h1 and h2 in the respective first and second regions, where h1 greater than h2 by at least about 5%. The first and second skin layers have outermost first major surfaces facing away from each other. Average separations between the outermost first major surfaces of the first and second skin layers are s1 and s2 in the respective first and second regions, where s1 and s2 are within less than about 5% of each other.

In some aspects, the present description provides an optical film including a plurality of polymeric layers disposed between, and coextruded with, first and second skin layers. Each of the polymeric layers can have a maximum thickness of less than about 700 nm. Each of the first and second skin layers can have a maximum thickness of greater than about 500 nm. The optical film includes a first region disposed between second and third regions, where each of the polymeric layers and the first and second skin layers extend seamlessly and continuously between and across the first through third regions. The first and second skin layers have outermost first major surfaces facing away from each other. Maximum separations between the outermost first major surfaces of the first and second skin layers in the first, second, and third regions are within about 10% of each other, such that for a substantially normally incident light, for at least one polarization state, and for first and second wavelengths that are at least 20 nm apart, the optical film has: for the first wavelength, an optical transmittance of greater than about 50% in each of the first, second and third regions; and for the second wavelength, an optical transmittance of greater than about 50% in the first region, and an optical transmittance of less than about 20% in each of the second and third regions.

In some aspects, the present description provides an optical film including a plurality of polymeric layers disposed between, and coextruded with, first and second skin layers. Each of the polymeric layers can have a maximum thickness of less than about 700 nm. Each of the first and second skin layers can have a maximum thickness of greater than about 500 nm. The optical film includes non-overlapping substantially parallel first and second regions extending along a length, and arranged along a width, of the optical film, where each of the polymeric layers and the first and second skin layers extend seamlessly and continuously between and across the first and second regions. The first and second skin layers have outermost first major surfaces facing away from each other. Maximum separations between the outermost first major surfaces of the first and second skin layers in the first and second regions are within about 10% of each other. Total optical thicknesses of the plurality of polymeric layers in the first and second regions are sufficiently different from each other so that for a substantially normally incident light, for at least one polarization state, and first and second wavelength ranges, each of the wavelength ranges being at least 20 nm wide, the plurality of polymeric layers has: an optical transmittance of greater than about 50% for each wavelength in the first wavelength range for the first, but not the second, region; and an optical transmittance of less than about 40% for each wavelength in the second wavelength range for each of the first and second regions. The first and second wavelength ranges can be less than about 200 nm apart.

In some aspects, the present description provides an optical film including a plurality of optical repeat units disposed between, and coextruded with, first and second skin layers. Each of the optical repeat units include at least two different polymeric layers. Each of the polymeric layers in the optical repeat units can have a maximum thickness of less than about 700 nm. Each of the first and second skin layers can have a maximum thickness of greater than about 500 nm. The optical film includes non-overlapping substantially parallel first and second regions extending along a length, and arranged along a width, of the optical film, where each of the polymeric layers in the optical repeat units and the first and second skin layers extend seamlessly and continuously between and across the first and second regions. The first and second skin layers have outermost first major surfaces facing away from each other. Maximum separations between the outermost first major surfaces of the first and second skin layers in the first and second regions can be within about 10% of each other. The optical film is such that for a substantially normally incident light, at least one polarization state, a visible wavelength range extending from about 420 nm to about 680 nm, and a first infrared wavelength that is in an infrared wavelength range extending from about 700 nm to at least about 1500, the plurality of the optical repeat units has: an average optical transmittance of greater than about 50% in the visible wavelength range for each of the first and second regions; and for the first infrared wavelength, an optical transmittance of greater than about 50% in the first region and an optical transmittance of less than about 40% in the second region.

These and other aspects will be apparent from the following detailed description. In no event, however, should this brief summary be construed to limit the claimable subject matter.

### BRIEF DESCRIPTION OF THE DRAWINGS

FIGS. 1-2 are schematic cross-sectional views of optical films, according to some embodiments.

FIGS. 3-5 are schematic top views of optical films, according to some embodiments.

FIG. 6 is a schematic illustration of optical transmittance of an optical film, or of layers or optical repeat units of an optical film, for substantially normally incident light versus wavelength, according to some embodiments.

FIG. 7 shows calculated plots of optical transmittance versus wavelengths for substantially normally incident light for regions of optical films, according to some embodiments.

FIG. 8 shows plots of thickness of layers of an optical film versus layer number which can result in the transmittance of FIG. 7, according to some embodiments.

FIG. 9 shows calculated plots of optical transmittance for substantially normally incident light versus wavelengths for first and second regions of an optical film, according to some embodiments.

FIG. 10 shows plots of average layer thickness of optical repeat units versus layer number which can result in the transmittance of FIG. 9, according to some embodiments.

FIG. 11 is a schematic plot of thickness of the layers of an optical film versus layer number in first and second regions of the optical film, according to some embodiments.

FIG. 12 is a plot of total optical thickness of a plurality of polymeric layers versus calculated transmittance through the layers for various wavelengths of substantially normally incident light, according to some embodiments.

FIG. 13 is a schematic cross-sectional view of a windshield which includes an optical construction that includes an optical film, according to some embodiments.

FIG. 14 is a schematic perspective view of a vehicle including a windshield, according to some embodiments.

FIG. 15 is a schematic cross-sectional view of an optical sensing system, according to some embodiments.

FIG. 16 is a schematic view of polymer flow channels of a feed block that may be used in producing a film of the present description, according to some embodiments.

FIG. 17 is a schematic perspective view of a portion of a plate used to create the polymer flow channels of FIG. 16, according to some embodiments.

FIG. 18 is a schematic cross-sectional view of a film that may be extruded as described for FIGS. 16-17, according to some embodiments.

FIG. 19 is a schematic cross-sectional view of a film that may be extruded as described for FIG. 16 but with a different skin plate, according to some embodiments.

FIGS. 20-21 are plots of transmission versus wavelength for light normally incident at various locations along a width of exemplary optical films.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

As is known in the art, multilayer optical films including alternating polymeric layers can be used to provide desired reflection and transmission in desired wavelength ranges by suitable selection of layer thicknesses and refractive index differences. Multilayer optical films and methods of making multilayer optical films are described in U.S. Pat. No. 5,882,774 (Jonza et al.); U.S. Pat. No. 6,783,349 (Neavin et al.); U.S. Pat. No. 6,949,212 (Merrill et al.); U.S. Pat. No. 6,967,778 (Wheatley et al.); and U.S. Pat. No. 9,162,406 (Neavin et al.), for example.

In some cases, it may be desired that a continuous optical film have different transmission and reflection spectra in different regions of the film. For example, it may be desired that an optical film reflect light over some wavelength range over a first portion of the film, but that the film be transmissive for at least some wavelengths in the wavelength range over a second portion of the film (e.g., a portion covering a sensor or a transmitter). One example of this is an infrared reflective film may be used in a windshield, for example, to reduce solar heating but it may be desired that a sensor or transmitter be able to sense or transmit one or more infrared wavelengths through the film in regions of the film adjacent the sensor or transmitter. According to some embodiments of the present description, it has been found that continuous optical films having different transmission spectra in different regions of the film can be made by coextrusion and co-stretching a plurality of optical layers disposed between skin layers where one or both skin layers have a non-uniform thickness generated by a skin plate and related material and flow rate choices, for example, as described further elsewhere herein. It has been found that the optical layers coextruded with the non-uniform thickness skin layer(s) can result in the optical layers having non-uniform thicknesses. For example, the optical layers can expand in thickness where the skin layer(s) are thinner resulting in the overall thickness of the film being constant or approximately constant.

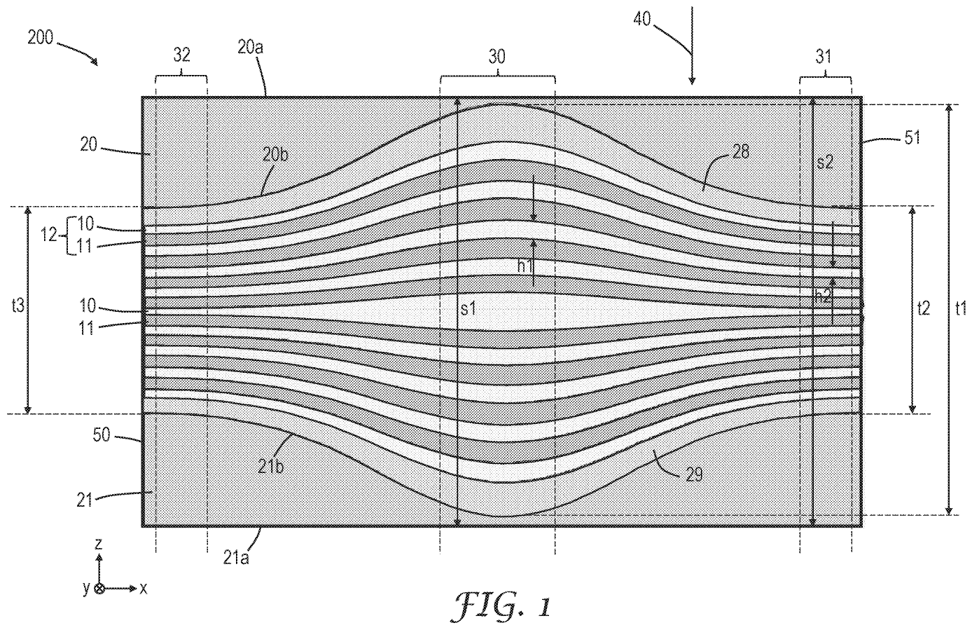

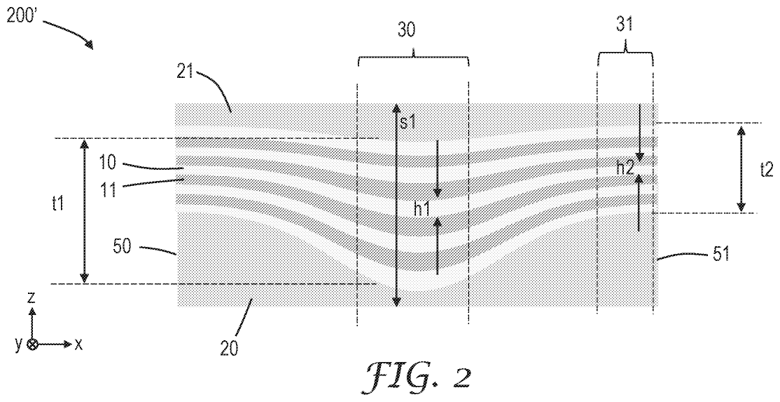

FIGS. 1-2 are schematic cross-sectional views of optical films, according to some embodiments. Optical films 200, 200′ include a plurality of polymeric layers 10, 11 disposed between skin layers 20, 21. In FIG. 1, skin layers 20 and 21 are coextruded with a non-uniform thickness profile such that the skin layers 20, 21 are thinner in region 30 and thicker in region 31. In this case, polymeric layers 10, 11 are correspondingly thicker in region 30 and thinner in region 31. In FIG. 2, skin layer 20 is coextruded with a non-uniform thickness profile such that the skin layer 20 is thinner in region 30 and thicker in region 31. In this case, polymeric layers 10, 11 and skin layer 21 are correspondingly thicker in region 30 and thinner in region 31. The optical film may also include layers 28 and 29 between the plurality of polymeric layers and the respective skin layers 20 and 21. Such layers may be protective boundary layers or may be layers (e.g., corresponding to portions 120b and 121b described elsewhere herein) coextruded with the respective skin layers 20 and 21 to aid in controlling the thickness profiles of the skin layers 20 and 21. As described further elsewhere herein, the optical film can have different transmission (and/or reflection) properties for substantially normally incident (e.g., withing about 30, 20, 10, or 5 degrees of normally incident) light 40 in the different regions.

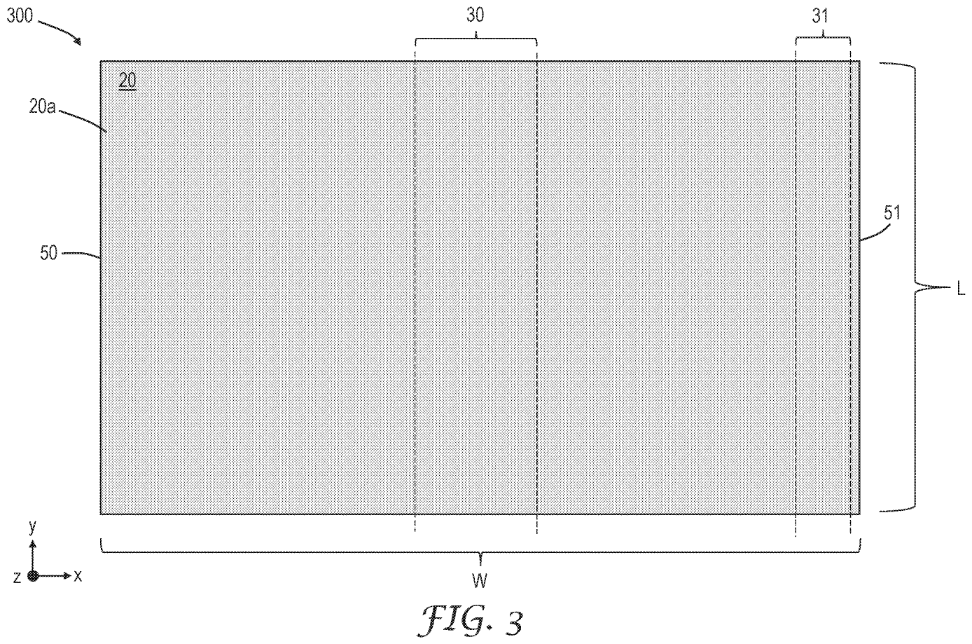

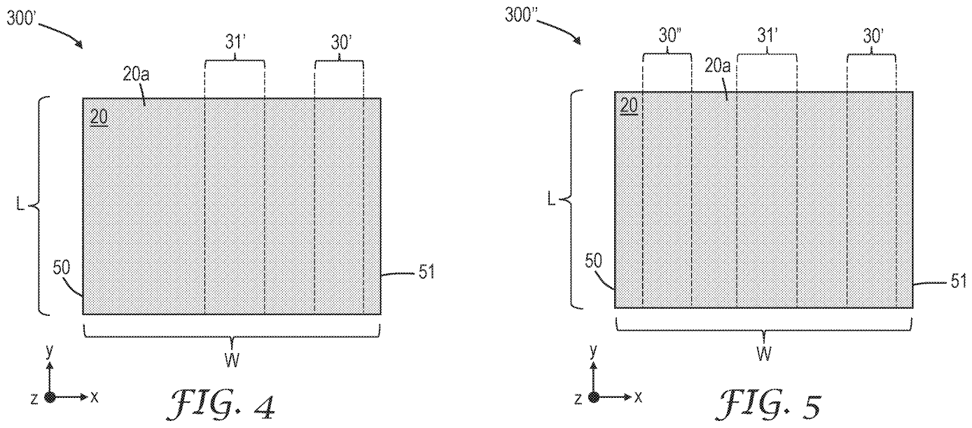

FIGS. 3-5 are schematic top views of optical films, according to some embodiments. Optical film 300 schematically illustrated in FIG. 3 may correspond to optical film 200 or 200′, for example. In FIG. 4, region 30′, which may correspond to region 30 and may be a region of thicker layers 10, 11, is closer to an edge 51 of the optical film 300′ than region 31′, which may correspond to region 31 and may be a region of thinner layers 10, 11. In FIG. 5, optical film 300″ includes a region 31′, which may correspond to region 31 and may be a region of thinner layers 10, 11, and includes a plurality of regions 30′, 30″ which may each correspond to region 30 and may each be a region of thicker layers 10, 11.

In some embodiments, an optical film 200, 200′, 300, 300′, 300″ includes a plurality of polymeric layers 10, 11 disposed between, and coextruded with, first (20) and second (21) skin layers. The plurality of polymeric layers 10, 11 may be or include a plurality of alternating first (10) and second (11) polymeric layers. In some embodiments, the first layers are birefringent, and the second layers are substantially optically isotropic. The polymeric layers 10, 11 may be arranged into optical repeat units 12. In some embodiments, an optical film 200, 200′, 300, 300′, 300″ includes a plurality of optical repeat units 12 disposed between, and coextruded with, first (20) and second (21) skin layers, where each of the optical repeat units include at least two different polymeric layers. An optical repeat unit is generally the smallest distinct unit of layers that repeats along a thickness direction of the optical film. An optical repeat unit generally includes at least two different layers and may optionally include additional layers as described in U.S. Pat. No. 5,103,337 (Schrenk et al.); U.S. Pat. No. 5,540,978 (Schrenk) and U.S. Pat. No. 6,207,260 (Wheatley et al.), for example.

The plurality of polymeric layers 10, 11 may number at least 10, 20, 30, 40 or 50 in total. The plurality of optical repeat units 12 may number at least 5, 10, 15, 20, 25 in total. The total number of layers in the plurality of polymeric layers 10, 11 and/or the total number of layers in the plurality of optical repeat units 12 may be up to 10000, 5000, 2000, 1000, or 800, for example.

In some embodiments, each of the polymeric layers 10, 11 has a maximum thickness of less than about 700, or 650, or 600, or 500, or 450, or 400, or 350, or 300, or 250, or 200, or 150 nm. In some embodiments, each of the polymeric layers 10, 11 has a minimum thickness of less than about 500, or 450, or 400, or 350, or 300, or 250, or 200, or 150 nm, or 130 nm. The maximum and/or minimum thickness of each of the layers 10, 11 can be greater than about 20, 30, 40, or 50 nm, for example. The maximum and minimum thickness of each of the polymeric layers in the optical repeat units 12 can be in any of these ranges. For example, in some embodiments, each of the polymeric layers in the optical repeat units 12 has a maximum thickness of less than about 700 nm. In some embodiments, each of the first and second skin layers 20 and 21 has a maximum thickness of greater than about 500, or 600, or 700, or 800, or 900, or 1000, or 1250, or 1500, or 1750, or 2000 nm. In some embodiments, each of the first and second skin layers 20 and 21 has a minimum thickness of greater than about 400, or 500, or 600, or 700, or 800, or 900, or 1000, or 1250, or 1500, or 1750 nm. The maximum thickness of each of the skin layers can be up to about 150, 100, 50, 30, 20, or 10 microns, for example. In some embodiments, the plurality of optical repeat units 12 are arranged into packets of optical repeat units separated by protective boundary layer(s) that each have minimum and maximum thicknesses in any of the ranges described for the skin layers, for example.

In some embodiments, the optical film includes non-overlapping substantially parallel first (30) and second (31) regions extending along a length (L, y-axis, referring to the illustrated x-y-z coordinate system), and arranged along a width (W, x-axis), of the optical film, where each of the polymeric layers 10, 11, and/or each of the polymeric layers in the optical repeat units 12, and the first and second skin layers 20, 21 extend seamlessly and continuously between and across the first and second regions 30, 31. The substantially parallel regions can be parallel to within 30, 20, 10, 5, 3, 2, or 1 degrees, for example, when the film is laid flat. In some embodiments, the optical film includes a first region 30 disposed between second and third regions 31 and 32, where each of the polymeric layers 10, 11, and/or each of the polymeric layers in the optical repeat units 12, and the first and second skin layers 20, 21 extend seamlessly and continuously between and across the first through third regions. In some embodiments, each of the polymeric layers 10, 11 have average thicknesses h1 and h2 in the respective first and second regions 30 and 31. The average thicknesses in a third region (e.g., region 32) may be about the same, or different, from one of h1 and h2. In some embodiments, each of the polymeric layers has average thicknesses h1 in the first region and h2 in each of the second and third regions. In some embodiments, each of the polymeric layers have average thicknesses h1 in each of the first and third regions 30 and 32 (e.g., corresponding to regions 30′ and 30″ in FIG. 5) and h2 in the second region 31 (e.g., correspond to region 31′ in FIG. 5). In some embodiments, h1 is greater than h2 by at least about 5%, or 7.5%, or 10%, or 12.5%, or 15%, or 17.5%, or 20%.

The first and second skin layers 20, 21 have outermost first major surfaces 20a, 21a facing away from each other (see, e.g., FIG. 1). The optical film can have approximately constant total thickness so that average, and/or maximum, separations between the outermost first major surfaces 20a, 21a of the first and second skin layers 20, 21 in the various regions of the optical film can be about the same. Average separations between the outermost first major surfaces 20a, 21a of the first and second skin layers 20, 21 are s1 and s2 in the respective first and second regions 30 and 31. In some embodiments, average separations between the outermost first major surfaces 20a, 21a of the first and second skin layers 20, 21 are s1 in the first region and s2 in each of the second and third regions. In some embodiments, s1 and s2 are within less than about 8%, or 7%, or 6%, or 5%, or 4%, or 3%, or 2%, or 1% of each other. In some embodiments, maximum separations between the outermost first major surfaces 20a, 21a of the first and second skin layers 20, 21 in the first and second regions 30, 31 are within about 10%, or 9%, or 8%, or 7%, or 6%, or 5%, or 4%, or 3%, or 2%, or 1% of each other. In some embodiments, maximum separations between the outermost first major surfaces 20a, 21a of the first and second skin layers 20, 21 in the first (30), second (31), and third (32) regions are within about 10%, or 9%, or 8%, or 7%, or 6%, or 5%, or 4%, or 3%, or 2%, or 1% of each other. In some embodiments, a maximum separation between the outermost first major surfaces 20a, 21a over substantially an entire area (e.g., over at least about 60, 70, 80, 90, 95, 97, 98, 99, or 99.5 percent of the entire area of a major surface) of the optical film is no more than about 15%, or 12%, or 10%, or 9%, or 8%, or 7%, or 6%, or 5%, or 4%, or 3%, or 2%, or 1% greater than a minimum separation between the outermost first major surfaces 20a, 21a over substantially the entire area the optical film.

In some embodiments, the first and second skin layers 20, 21 have innermost second major surfaces 20b, 21b facing each other, where average separations between the innermost major surfaces of the first and second skin layers are t1 and t2 in the respective first and second regions 30 and 31. In some embodiments, t1 is greater than t2 by at least about 5%, or 7.5%, or 10%, or 12.5%, or 15%, or 17.5%, or 20%. t1 may be greater than t2 by up to about 100, 80, 60, or 40 percent, for example. In some embodiments, an average separation between the innermost major surfaces of the first and second skin layers is t3 in a third region (e.g., region 32). In some embodiments, t3 is about equal to one of t1 and t2. For example, in the embodiment schematically illustrated in FIG. 1, t3 is about equal to t2. In other embodiments, t3 can be different from each of t1 and t2. In some embodiments, t1 is greater than each of t2 and t3 by at least about 5%, or 7.5%, or 10%, or 12.5%, or 15%, or 17.5%, or 20%.

In some embodiments, the first and second regions 30 and 31 extend substantially along an entire length L (e.g., along y-axis) of the optical film (e.g., along at least about 60, 70, 80, 90, or 95 percent of the entire length). In some embodiments, the optical film is substantially uniform along the entire length L of the optical film. For example, the composition and thickness of each layer of the optical film may be substantially constant (e.g., thickness varying by less than about 12, 10, 8, 6, 5, 4, 3, 2 or 1 percent) along the entire length L.

The optical film 200, 200′, 300, 300′, 300″ can have opposing first (50) and second (51) longitudinal edges extending along the length of the optical film. In some embodiments, the first longitudinal edge 50 is closer to the first region 30 and the second longitudinal edge 51 is closer to the second region 31, and the second region 31 is disposed between the first region 30 and the second longitudinal edge 51 (see, e.g., FIGS. 1-3). In some embodiments, the first longitudinal edge 50 is closer to the second region 31′ and the second longitudinal edge 51 is closer to the first region 30′, and the first region 30′ is disposed between the second region 31′ and the second longitudinal edge 51 (see, e.g., FIGS. 4-5). In some embodiments, the first region 30 is disposed between the second and third regions 31 and 32. In some embodiments, the first longitudinal edge 50 is closest to the third region 32 and the second longitudinal edge 51 is closest to the second region 31. In some embodiments, the optical film includes a plurality of the first regions 30′, 30″ (see, e.g., FIG. 5). In some embodiments, the second region 31′ is disposed between two neighboring first regions in the plurality of the first regions.

In some embodiments, the optical film has a predetermined spatially variant optical transmittance. This may be achieved by varying the thickness of the polymeric layers 10, 11 to shift a reflection band provided by the polymeric layers 10, 11 to different wavelengths. For example, in embodiments where the optical film has a reflection band in region 31 of FIGS. 1-2, for example, the reflection band can be shifted to larger wavelengths in region 30 where the layers 10, 11 are thicker.

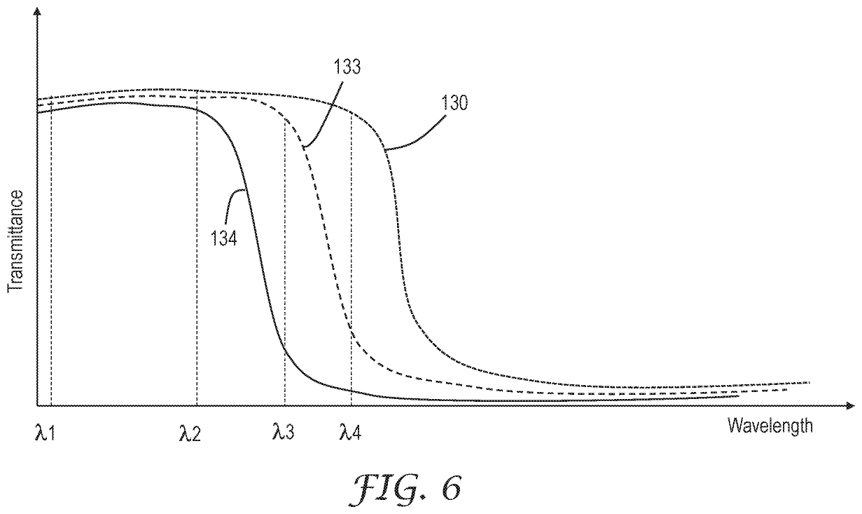

FIG. 6 is a schematic illustration of optical transmittance of an optical film, or of a plurality of polymeric layers 10, 11, or of a plurality of optical repeat units 12, for substantially normally incident light versus wavelength, according to some embodiments. The transmittance curves 130, 133 and 134 correspond to different regions of the optical film where the plurality of layers 10, 11 are generally thickest in the region(s) corresponding to the transmittance curve 130, thinnest in the region(s) corresponding to transmittance curve 134, and have intermediate thicknesses in the region(s) corresponding to transmittance curve 133. Wavelengths λ1, λ2, λ3, λ4 are schematically illustrated. In some embodiments, wavelengths λ1 and λ2 are visible wavelengths (e.g., each in a range of 400 nm to 700 nm) and wavelengths λ3 and λ4 are infrared wavelengths (e.g., each in a range of 700 nm to 4000 nm). In some embodiments, λ1 is about 420 nm, λ2 is about 680 nm, λ3 is about 700 nm, and λ4 is at least about 800, 900, 1000, 1100, 1200, 1300, 1400, 1500, 1800, 2000, 2500, or 3000 nm. In some embodiments, λ4 may be up to about 6000, 5000, 4000, 3000, 2500, 2000, 1900, 1800, 1700, or 1600 nm. For example, 24 may be in a range of about 1000 nm to about 3000 nm. For transmittance curve 130, the transmittance can be greater than about 50%, or 55%, or 60%, or 65%, or 70%, or 75%, or 80% for each of the wavelengths λ1, λ2, λ3 and λ4. For transmittance curve 133, the transmittance can be greater than about 50%, or 55%, or 60%, or 65%, or 70%, or 75%, or 80% for each of the wavelengths λ1, λ2 and λ3, but less than about 40%, or 35%, or 30%, or 25%, or 20%, or 15%, or 10%, or 5% for the wavelength λ4. For transmittance curve 134, the transmittance can be greater than about 50%, or 55%, or 60%, or 65%, or 70%, or 75%, or 80% for each of the wavelengths λ1 and λ2, but less than about 40%, or 35%, or 30%, or 25%, or 20%, or 15%, or 10%, or 5% for each of the wavelengths λ3 and λ4.

The optical film can be reflective for at least one polarization state. For example, the optical film can be a reflective polarizer that substantially reflects a first polarization state and substantially transmits an orthogonal second polarization state for at least a first wavelength range, or the optical film can be a mirror film that substantially reflects each of the first and second polarization states for the first wavelength range. The various transmission plots shown herein can be understood to be for at least one polarization state where each of the at least one polarization state is reflected by the optical film over at least some wavelength range. For example, the transmission curves of FIG. 6 can be understood to be for the first polarization state in the case of a reflective polarizer or for unpolarized light in the case of a mirror film.

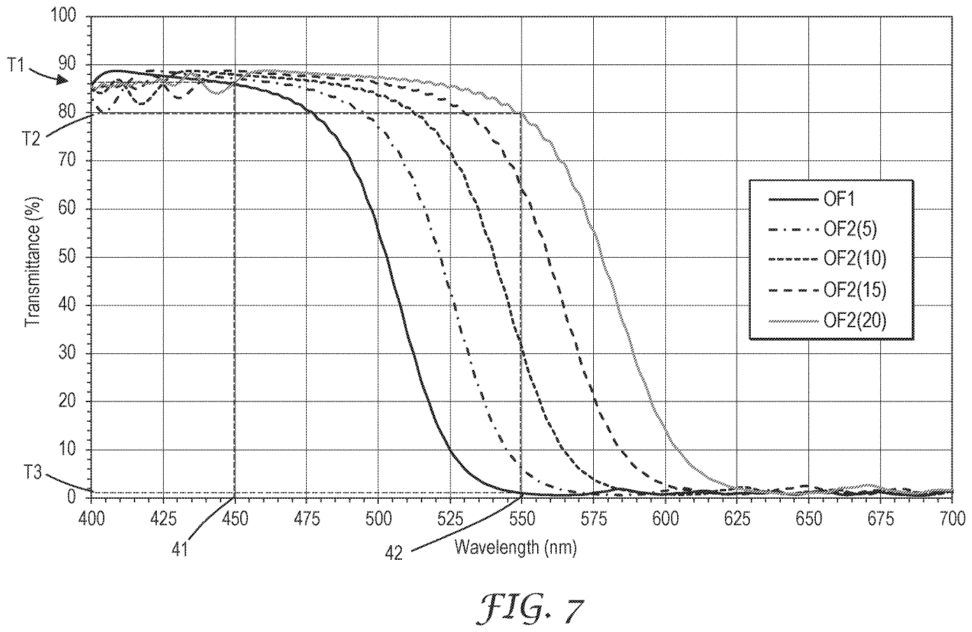

FIG. 7 shows calculated plots of optical transmittance versus wavelengths for substantially normally incident light for regions of optical films, according to some embodiments. In FIG. 7, a thinner region of an optical film is denoted OF1 while a thicker region of the optical film is denoted OF2(N) where N represents an approximate percent (5%, 10%, 15%, 20%) increase in thickness of the layers 10, 11 in the thicker region. Average transmittances in wavelength ranges of 525 nm to 450 nm and 550 nm to 575 nm in the various regions of the optical films are reported in the table below.

| Wavelength | | | | | |
|---|---|---|---|---|---|
| Range (nm) | OF1 | OF2(5) | OF2(10) | OF2(15) | OF2(20) |
| 525-450 | 86.8 | 87.8 | 88.2 | 86.2 | 86.0 |
| 550-575 | 0.7 | 2.5 | 14.1 | 43.5 | 69.8 |

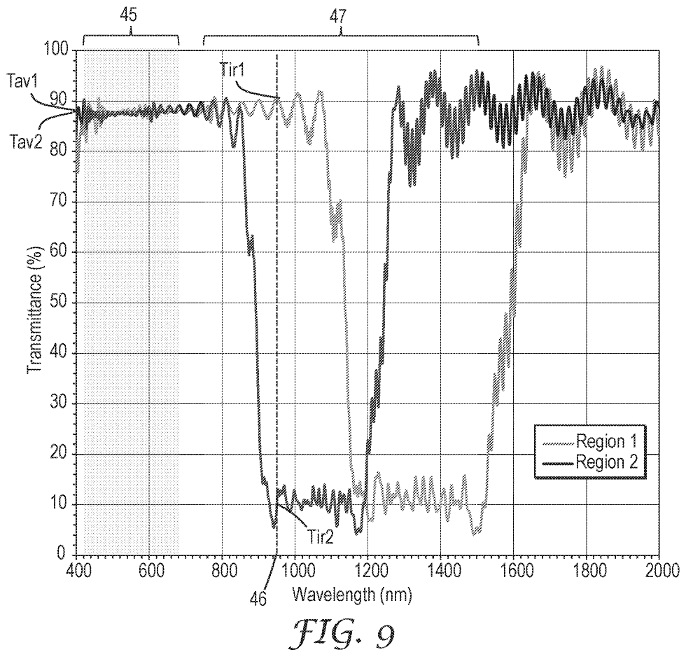

In some embodiments, the optical film 200, 200′, 300, 300′, 300″ is such that for a substantially normally incident light 40 (see, e.g., FIG. 1), for at least one polarization state (e.g., polarized along x-axis), and for first (41) and second (42) wavelengths that are at least 20 nm apart (see, e.g., FIG. 7), the optical film has: for the first wavelength 41, an optical transmittance T1 of greater than about 50% in each of the first (e.g., 30), second (e.g., 31) and third (e.g., 32) regions; and for the second wavelength, an optical transmittance T2 of greater than about 50% in the first region, and an optical transmittance T3 of less than about 20% in each of the second and third regions. In some such embodiments, or in other embodiments, the optical transmittance T1 is greater than about 55%, or 60%, or 65%, or 70%, or 75%, or 80% in each of the first, second and third regions. In some embodiments, or in other embodiments, the optical transmittance T2 is greater than about 55%, or 60%, or 65%, or 70%, or 75%, or 80% in the first region. In some embodiments, or in other embodiments, the optical transmittance T3 is less than about 15% in each of the second and third regions. The first and second wavelengths 41 and 42 can be at least 30, or 40, or 50, or 60, or 70, or 80, or 90, or 100, or 110, or 120, or 130, or 140, or 150 nm apart. The first and second wavelengths 41 and 42 may be up to 4000, 3000, 2000, or 1000 nm apart, for example. In some embodiments, the first wavelength 41 is about 450 nm and the second wavelength is about 550 nm. In some embodiments, the first wavelength 41 is a visible wavelength in a visible wavelength range (see, e.g., visible wavelength range 45 depicted in FIG. 9) extending from about 420 nm to about 680 nm, and the second wavelength is an infrared wavelength (e.g., wavelength 46 depicted in FIG. 9) in an infrared wavelength range (see, e.g., infrared wavelength range 47 depicted in FIG. 9) extending from about 700 nm to at least about 1500, or 2000, or 2500, or 3000 nm.

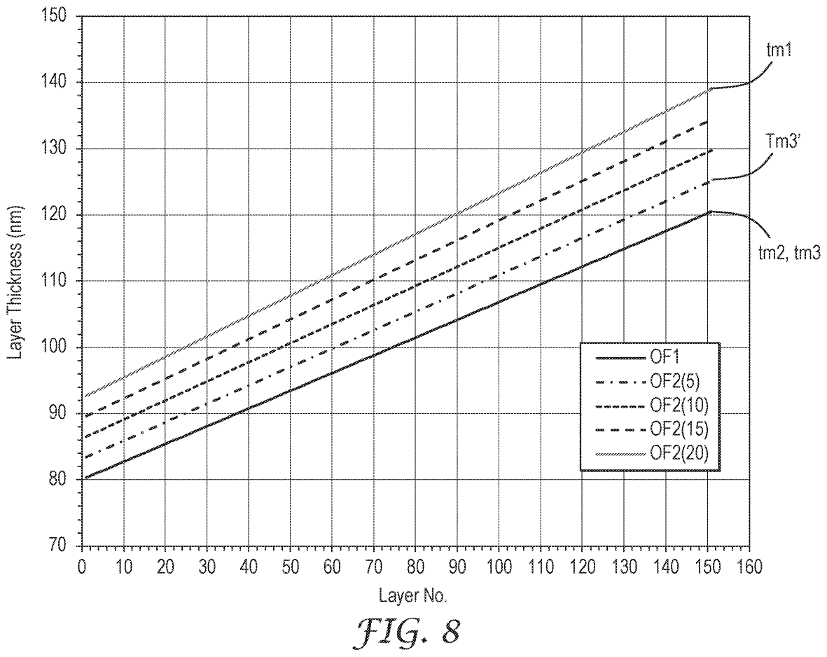

FIG. 8 shows plots of thickness of the layers 10, 11 versus layer number which can result in the transmittance of FIG. 7, according to some embodiments. The materials of the layers of FIG. 8 that result in the transmittance of FIG. 7 can be polyethylene naphthalate (PEN) for the high index optical layers (e.g., layers 10) and polymethylmethacrylate (PMMA) for the low index optical layers (e.g., layers 11). Other suitable polymeric materials for the various layers of the optical film are described, for example, in the multilayer optical film references provided elsewhere herein. In some embodiments, the plurality of polymeric layers 10, 11 in first (e.g., 30), second (e.g., 31), and third (e.g., 32) regions have respective maximum layer thicknesses tm1, tm2, and tm3 (or tm3′, for example), where tm1 is greater than each of tm2 and tm3 (or tm3′, for example) by at least 2%, or 3%, or 4%, or 5%, or 6%, or 7%, or 8%, or 9%, or 10%, or 11%, or 12%, or 13%, or 14%, or 15%. tm1 may be greater than tm2 and/or tm3 and/or tm3′ by up to about 100, 80, 60, or 40 percent, for example. The maximum layer thickness in the third region (e.g., tm3 or tm3′) can be about the same (e.g., tm3) as, or different (e.g., tm3′) from, the maximum layer thickness tm2 in the second region. Minimum and maximum thicknesses of the layers 10, 11 for the various regions of the optical films are reported in the table below.

| | OF1 | OF2(5) | OF2(10) | OF2(15) | OF2(20) |
|---|---|---|---|---|---|
| Minimum | 80.3 | 83.4 | 86.5 | 89.6 | 92.7 |
| Thickness (nm) | | | | | |
| Maximum | 120.5 | 125.1 | 129.8 | 134.4 | 139.0 |
| Thickness (nm) | | | | | |

FIG. 9 shows calculated plots of optical transmittance for substantially normally incident light versus wavelengths for first and second regions of an optical film, according to some embodiments. The average transmittance over the wavelength range of 420 nm to 680 nm for substantially normally incident light was about 87.6% in each of the first (Region 1) and second (Region 2) regions (Tav1 and Tav2, respectively). The transmittance for substantially normally incident light at a wavelength of 950 nm was about 90.7% in the first region and 8.6% in the second region.

In some embodiments, the optical film 200, 200′, 300, 300′, 300″ is such that for a substantially normally incident light 40, at least one polarization state (e.g., polarized along the x-axis), a visible wavelength range 45 extending from about 420 nm to about 680 nm, and a first infrared wavelength 46 that is in an infrared wavelength range 47 extending from about 700 nm to at least about 1500 nm, the plurality of the optical repeat units 12 has: an average optical transmittance (Tav1 and Tav2 in Regions 1 and 2, respectively) of greater than about 50%, or 55%, or 60%, or 65%, or 70%, or 75%, or 80%, or 85% in the visible wavelength range for each of the first and second regions (e.g., 30 and 31); and for the first infrared wavelength, an optical transmittance Tir1 of greater than about 50% in the first region and an optical transmittance Tir2 of less than about 40% in the second region. In some such embodiments, or in other embodiments, the optical transmittance Tir1 is greater than about 55%, or 60%, or 65%, or 70%, or 75%, or 80%, or 85%, or 90%. In some such embodiments, or in other embodiments, the optical transmittance Tir2 is less than about 35%, or 30%, or 25%, or 20%, or 15%, or 10%.

The infrared wavelength range 47 can extend from about 700 nm to at least about 2000, 2500, or 3000 nm, for example. In some embodiments, the infrared wavelength range 47 extends from about 700 nm to about 3000, 2500, 2000, or 1500 nm. In some embodiments, the first infrared wavelength is in a range of about 850 nm to about 950 nm, or about 900 nm to about 950 nm. In some embodiments, the first infrared wavelength is about 860 nm, about 905 nm, or about 940 nm. The optical film can be configured to have a high transmittance for the first infrared wavelength in the first region but not the second region where the first infrared wavelength can be selected based on an intended application where transmission at a predetermined infrared wavelength is desired. For example, a wavelength of about 860 nm can be used in some rain sensors and a wavelength of about 905 nm or about 940 nm can be used in some Light Detection and Ranging (Lidar) systems.

In some embodiments, the optical film comprises a third region 32 as described further elsewhere herein. In some embodiments, the optical film is such that for the substantially normally incident light 40 and the at least one polarization state (e.g., polarized along the x-axis), the plurality of the optical repeat units 12 in the third region has: an average optical transmittance (which in some embodiments is about equal to Tav1) of greater than about 50% in the visible wavelength range; and for a second infrared wavelength, which may be the same or different from the first infrared wavelength 46, that is in the infrared wavelength range 47, an optical transmittance (which in some embodiments is about equal to Tir1) of greater than about 50% in the third region. The average optical transmittance can be greater than about 55%, or 60%, or 65%, or 70%, or 75%, or 80%, or 85% in the visible wavelength range in the third region. The optical transmittance for the second infrared wavelength can be greater than about 55%, or 60%, or 65%, or 70%, or 75%, or 80%, or 85%, or 90% in the third region. In some embodiments, the first and second infrared wavelengths, which can be the same or different, are independently selected from the group consisting of about 860 nm, about 905 nm, or about 940 nm. In some embodiments, the first infrared wavelength is in a range of about 900 nm to about 950 nm and the second infrared wavelength is in a range of about 800 to about 880 nm.

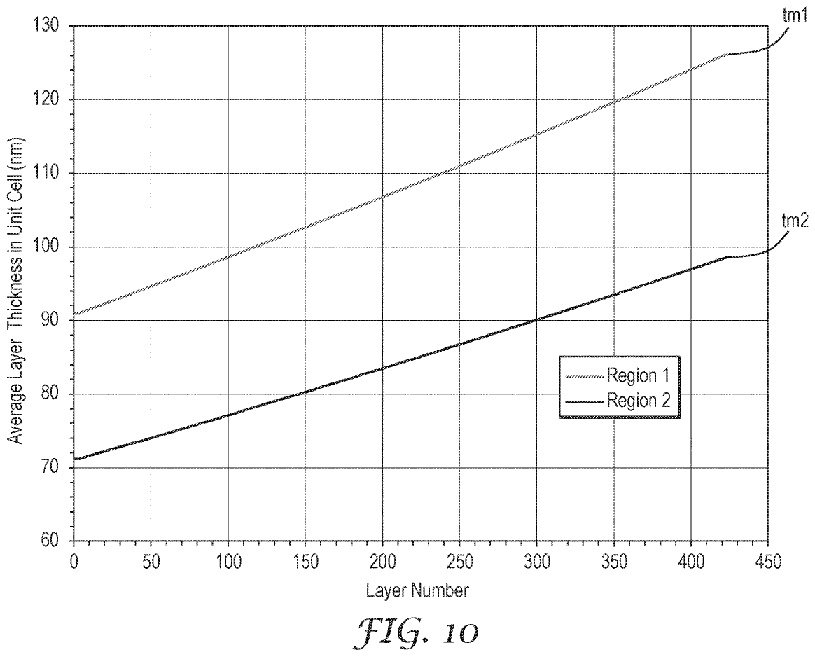

FIG. 10 shows plots of average thickness of layers of the unit cell or optical repeat unit 12 versus layer number which can result in the transmittance of FIG. 9, according to some embodiments. The materials of the layers of FIG. 10 that result in the transmittance of FIG. 9 can be from a 4-layer optical repeat unit having an ACBC structure using polyethylene terephthalate (PET) A layers, co-polymethylmethacrylate (coPMMA) B layers, and glycol modified PET (PETg) C-layers. Such 4-layer optical repeat units can be used to suppress harmonics in the visible range, for example, as generally described in U.S. Pat. No. 5,103,337 (Schrenk et al.) and U.S. Pat. No. 6,207,260 (Wheatley et al.), for example. In some embodiments, the plurality of polymeric layers 10, 11 in the first (Region 1) and second (Region 2) regions have respective maximum layer thicknesses tm1 and tm2, where tm1 is greater than tm2 by at least 2%, or 3%, or 4%, or 5%, or 6%, or 7%, or 8%, or 9%, or 10%, or 11%, or 12%, or 13%, or 14%, or 15%, for example.

In some embodiments, in each of the first and second regions, a thinnest polymeric layer in the plurality of polymeric layers is closest to the outermost first major surface of a same skin layer in the first and second skin layers. This is schematically illustrated in FIGS. 8 and 10, for example, where the thinnest layers in each of the regions is disposed on a same side (side with low layer or unit cell number).

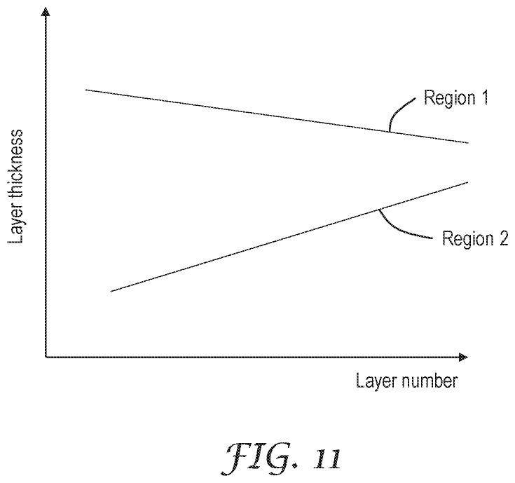

FIG. 11 is a schematic plot of thickness of the layers 10, 11 versus layer number of an optical film which may correspond to FIG. 2, according to some embodiments. As schematically illustrated in FIG. 11, for example, in some embodiments, a thinnest polymeric layer in the plurality of polymeric layers in the first region (Region 1) is closest to the outermost first major surface of one of the first and second skin layers (the skin layer adjacent the higher layer number polymeric layers in the illustrated embodiment), and a thinnest polymeric layer in the plurality of polymeric layers in the second region (Region 2) is closest to the outermost first major surface of the other one of the first and second skin layers (the skin layer adjacent the lower layer number polymeric layers in the illustrated embodiment). The layer thickness of FIG. 11, and/or other layer thickness plots described elsewhere herein, can be individual layer thickness or average layer thickness of the optical repeat units.

In some embodiments, as schematically illustrated in FIGS. 8, 10 and 11, for example, in at least one of the first second regions, the thicknesses of the polymeric layers increase monotonically from one major side of the polymeric layers facing one of the first and second skin layers to an opposite major side of the polymeric layers facing the other one of the first and second skin layers. In some embodiments, as schematically illustrated in FIGS. 8 and 10, for example, in each of the first second regions, the thicknesses of the polymeric layers increase monotonically from one major side of the polymeric layers facing a same one of the first and second skin layers to an opposite major side of the polymeric layers facing the other one of the first and second skin layers. In some embodiments, as schematically illustrated in FIG. 11, for example, in the first region, the thicknesses of the polymeric layers decrease monotonically from a first major side of the polymeric layers facing one of the first and second skin layers to an opposite second major side of the polymeric layers facing the other one of the first and second skin layers, and in the second region, the thicknesses of the polymeric layers increase monotonically from the first major side of the polymeric layers to the opposite second major side of the polymeric layers.

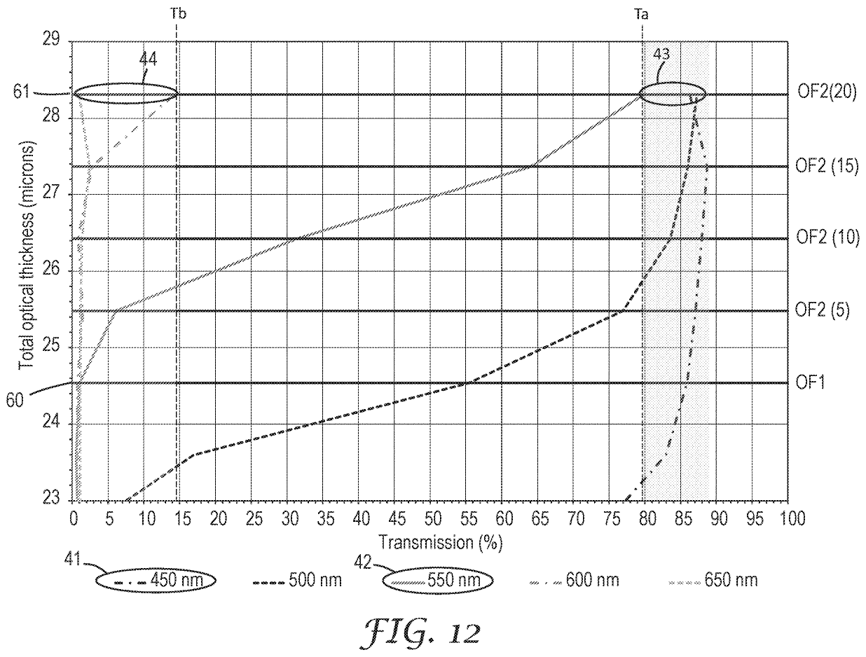

FIG. 12 is a plot of total optical thickness of the plurality of polymeric layers 10, 11 of an optical film versus calculated transmittance through the optical film for various wavelengths of substantially normally incident light, according to some embodiments. Total optical thicknesses are indicated in FIG. 12 for the plurality of polymeric layers 10, 11 for the regions/films of FIGS. 7-8. In some embodiments, total optical thicknesses 60, 61 of the plurality of polymeric layers 10, 11 in the first and second regions 30 and 31 are sufficiently different from each other so that for a substantially normally incident light 40, for at least one polarization state (e.g., polarized along x-axis), and first (43) and second (44) wavelength ranges where each of the wavelength ranges is at least 20 nm wide, the plurality of polymeric layers 10, 11 has: an optical transmittance Ta of greater than about 50% (transmittance ≥Ta) for each wavelength in the first wavelength range for the first, but not the second, region; and an optical transmittance of less than about 40% (transmittance≤Tb) for each wavelength in the second wavelength range for each of the first and second regions. In some such embodiments, or in other embodiments, the plurality of polymeric layers 10, 11 has an optical transmittance greater than about 55%, or 60%, or 65%, or 70%, or 75%, or 80% for each wavelength in the first wavelength range for the first, but not the second, region. In some such embodiments, or in other embodiments, the plurality of polymeric layers 10, 11 has an optical transmittance of less than about 35%, or 30%, or 25%, or 20%, or 15%, or 10%, or 5% for each wavelength in the second wavelength range for each of the first and second regions. The optical transmittances of the plurality of optical repeat units 12 can be in any of the ranges described for the plurality of polymeric layers 10, 11.

In the embodiments schematically illustrated in FIG. 12, the total optical thickness 60 is about 24.5 microns and the total optical thickness 61 is about 28.3 microns. In some embodiments, the total optical thicknesses 60 and 61 may be in respective ranges of 23 microns to 26 microns and 27 microns to 30 microns, for example. In other embodiments, different ranges of optical thicknesses are used to provide reflection bands in different wavelength ranges. In some embodiments, the total optical thicknesses of the plurality of polymeric layers in the first and second regions are different from each other by at least about 5%, or 7%, or 9%, or 10%, or 12%, or 15%, or 20%, or 25%, or 30%.

The first and second wavelength ranges 43 and 44 schematically depicted in FIG. 12 are wavelengths in the range indicated by the circled curves for the illustrated embodiment. For example, the first wavelength range 43 can be from about 450 nm to about 550 nm and the second wavelength range 44 can be from about 600 nm to about 650 nm. In some embodiments, the first wavelength range is a visible wavelength range 45 (see, e.g., FIG. 9) extending from about 420 nm to about 680 nm, and the second wavelength range is an infrared wavelength range 47 extending from about 700 nm to at least about 1000, or 1100, or 1200, or 1300, or 1400, or 1500, or 2000, or 2500 nm. In some embodiments, each of the first and second wavelength ranges 43 and 44 is at least 25 nm, or 30 nm, or 35 nm, or 40 nm, or 45 nm, or 50 nm, or 60 nm, or 70 nm, or 80 nm, or 100 nm wide. In some embodiments, the first and second wavelength ranges 43 and 44 are less than about 200, or 180, or 160, or 140, or 120, or 100 nm apart. For example, the first wavelength range 43 can be from about 450 nm to about 650 nm and the second wavelength range 44 can be from about 700 nm to about 1000 nm so that the first and second wavelength ranges are about 50 nm apart.

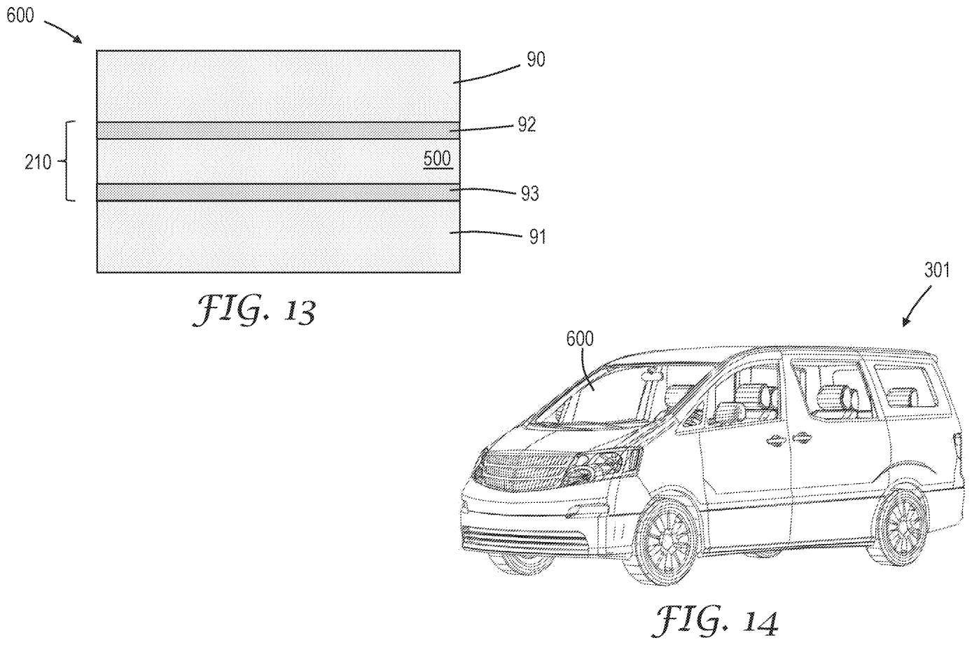

In some embodiments, the optical film 200, 200′, 300, 300′, 300″ is used in an optical construction which may be a windshield or a portion of a windshield, for example. FIG. 13 is a schematic cross-sectional view of a windshield 600 which includes an optical construction 210 that includes an optical film 500 that can correspond to any optical film described elsewhere herein, according to some embodiments. FIG. 14 is a schematic perspective view of a vehicle 301 including the windshield 600, according to some embodiments. In some embodiments, an optical construction 210 includes an optical film 500 bonded to at least one bonding layer 92, 93. In some embodiments, an optical construction 210 includes the optical film 500 disposed between and bonded to first (92) and second (93) bonding layers. In some embodiments, an optical construction, which may be a windshield, includes the optical film 500 disposed between, and bonded to, first (90) and second (91) substrates. In some embodiments, a windshield 600 of a vehicle 301 includes the optical film 500 disposed between, and bonded to, first (90) and second (91) substrates. In some embodiments, at least one of the first and second substrates comprises glass. In some embodiments, each of the first and second substrates comprises glass. In some embodiments, the optical film 500 is bonded to the first and second substrates 90, 91 via respective first and second bonding layers 92 and 93. In some embodiments, at least one of the first and second bonding layers comprises one or more of a polyvinyl butyral (PVB), a pressure sensitive adhesive (PSA), an ethylene vinyl acetate (EVA), a polyolefin, and a polyurethane. In some embodiments, for a substantially normally incident light 40 and for the first infrared wavelength 46, each of the first and second bonding layers has an average optical transmittance of greater than about 60%, or 70%, or 80%, or 90%.

In some embodiments, an optical film of the present description is used in an optical system to allow transmission of (e.g., near infrared) light from a transmitter and/or to a sensor while blocking (e.g., reflecting) other wavelengths (e.g., other infrared wavelengths to reduce solar heating). The optical sensing system may be, or may be a portion of, a rain sensing system or a Lidar system, for example. The optical film may be used in a windshield that is included in the optical sensing system. The optical film 500 can have a region 30 where the layers 10, 11 are thicker than in other regions of the optical film disposed adjacent to, and extending along, an edge (e.g., a bottom edge) of the windshield so that sensor and/or transmitters can communicate through the region of the optical film along the edge of the windshield.

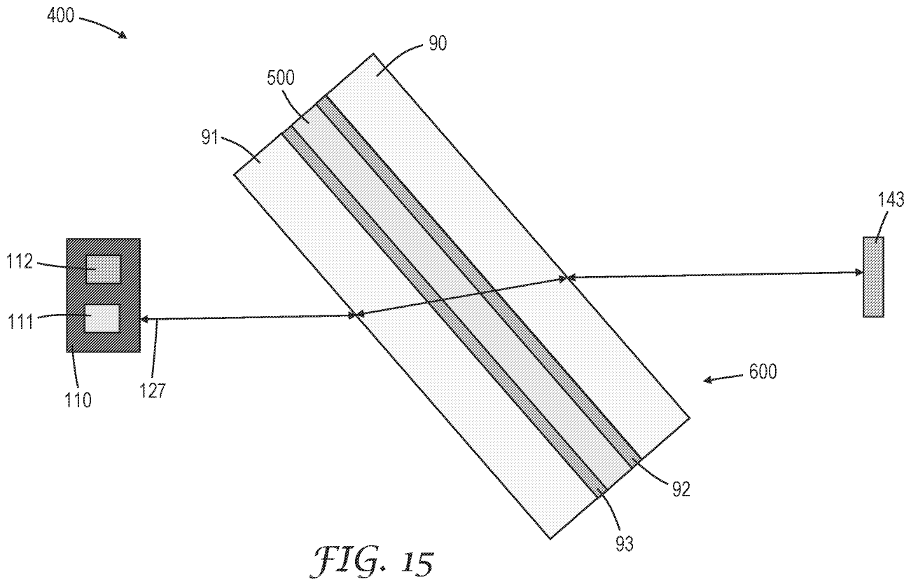

FIG. 15 is a schematic cross-sectional view of an optical sensing system 400, according to some embodiments. In the illustrated embodiment, the optical sensing system 400 includes the windshield 600, and a transceiver 110 including at least one of a transmitter 111 and a receiver 112 and configured to at least one of emit and receive a first light 127 toward an object 143 through the windshield. The first light 127 can have the first infrared wavelength 46 which, in some embodiments, is substantially transmitted through the optical film in one or more regions of the optical film.

In some embodiments, the transceiver 110 includes at least one transmitter 111 and at least one receiver 112. In some embodiments, the transmitter 111 includes a laser light source. In some embodiments, the receiver 112 includes an optical detector. In some embodiments, the receiver 112 includes a camera. In some embodiments, the transceiver 110 included at least one transmitter that emits the first light 127. In some embodiments, the emitted first light comprises a pulsed laser light. In some embodiments, the emitted first light comprises a continuous laser light. In some embodiments, the continuous laser light is at least one of phase and frequency modulated.

In some embodiments, the emitted first light has a wavelength in a range of about 800 nm to about 1800 nm. Useful wavelengths include about 860 nm (e.g., for rain sensors), about 905 nm (e.g., for some Lidar units), about 940 nm (e.g., for some other Lidar units), or about 1550 nm (e.g., for still some other Lidar units). In some embodiments, the emitted first light has a wavelength in a range of about 850 nm to about 950 nm, or about 900 nm to about 950 nm. In some embodiments, the emitted first light has a wavelength in a range of about 1400 nm to about 1700 nm, or about 1500 nm to about 1600 nm. The emitted first light can have the first infrared wavelength 46.

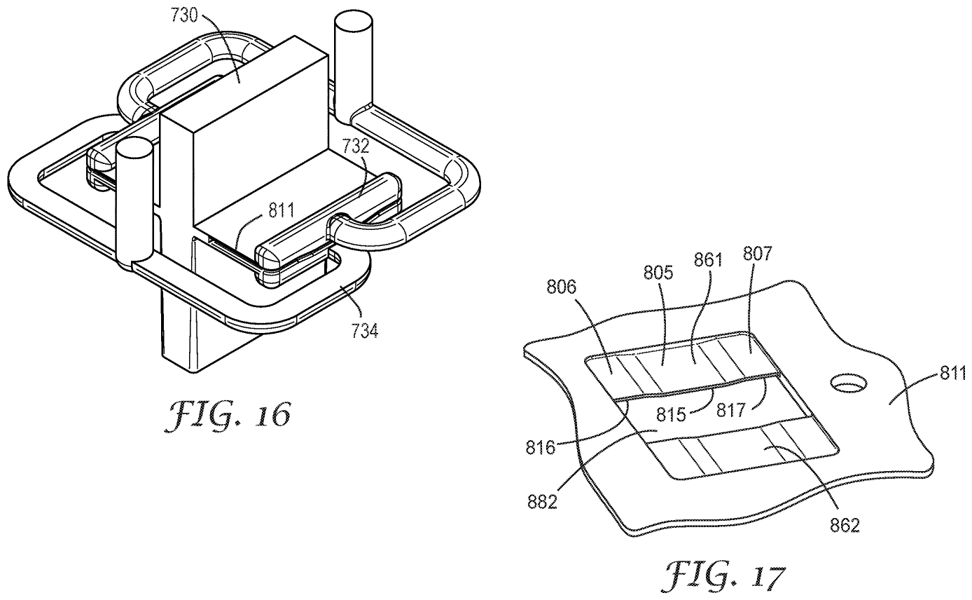

Various exemplary methods of making the optical films of the present description are described in the following with reference to FIGS. 16-19.

FIG. 16 is a schematic view of polymer flow channels of a feed block that may be used in producing a film of the present description, according to some embodiments. Suitable feed blocks can be made using commonly used techniques for making feed blocks (see, e.g., the multilayer optical film references provided elsewhere herein). In the illustrated embodiment, skin layers are provided on both sides of the molten stream 730 that contains a plurality of polymeric layers 10, 11, for example. Flow is provided on top (stream 732) and bottom (stream 734) sides of plate 811 to produce each of the skin layers. FIG. 17 is a schematic perspective view of a portion of a plate 811, according to some embodiments. One skin layer can be made by directing molten polymer flow over the top major surface of portion 861 of plate 811 defining regions 805, 806, 807 and over the bottom major surface of portion 861 of plate 811 defining regions 815, 816 and 817 of portion 861 of plate 811. Similarly, the opposite skin layer can be made by directing molten polymer flow over the top and bottom major surfaces of portion 862 of plate 811. The molten stream 730 can be passed through the space 882. Other methods of extruding profiled layers are described in U.S. Pat. Appl. Pub. No. 2020/0189164 (Free et al.), for example.

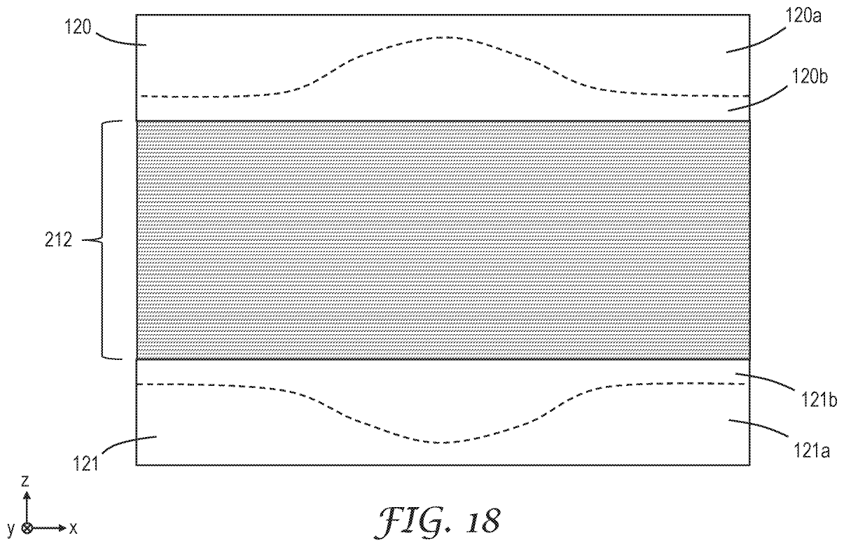

FIG. 18 is a schematic cross-sectional view of a film that may be extruded as described for FIGS. 16-17, according to some embodiments. The film includes a plurality 212 of optical repeat units disposed between skin layers 120, 121. The optical repeat units of the plurality 212 of optical repeat units can each include at least 2 layers. For example, each optical repeat unit can be a two layer optical repeat unit or can be a four layer optical repeat unit (e.g., an ACBC unit cell), as described elsewhere herein. The skin layer 120 includes an outer portion 120a and an inner portion 120b disposed between the outer portion 120a and the plurality 212 of optical repeat units (e.g., corresponding to optical repeat units 12). The outer portion 120a and the inner portion 120b may be formed from the flow streams 734 and 732 and may have a same (in which case, there may be no identifiable interface between the two portions after extrusion) or different compositions. Similarly, skin layer 121 includes an outer portion 121a and an inner portion 121b, which may have a same or different composition as the outer portion 121a, disposed between the outer portion 121a and the plurality 212 of optical repeat units. If the flow rates of the outer and inner portions of the skin layers are suitably balanced, the resulting film may be as schematically shown in FIG. 18. However, it has been found that if the flow rates for the inner portions 120b and 121b are reduced while the flow rates for the plurality 212 of optical repeat units are increased, the thickness of the polymeric layers of the optical repeat units will expand in the portion(s) of the film where the inner portions 120b and 121b were thickest so that the resulting film will appear as schematically illustrated in FIG. 1, for example. Skin layers 120 and 121 may correspond to skin layers 20 and 21, or outer portions 120a and 121a may corresponds to skin layers 20 and 21 and inner portions 120b and 121b may correspond to layers 28 and 29, for example. If the flow rate of one, but not the other, of the inner portions 120b and 121b are reduced, the resulting film can be made to appear as schematically illustrated in FIG. 2, for example.

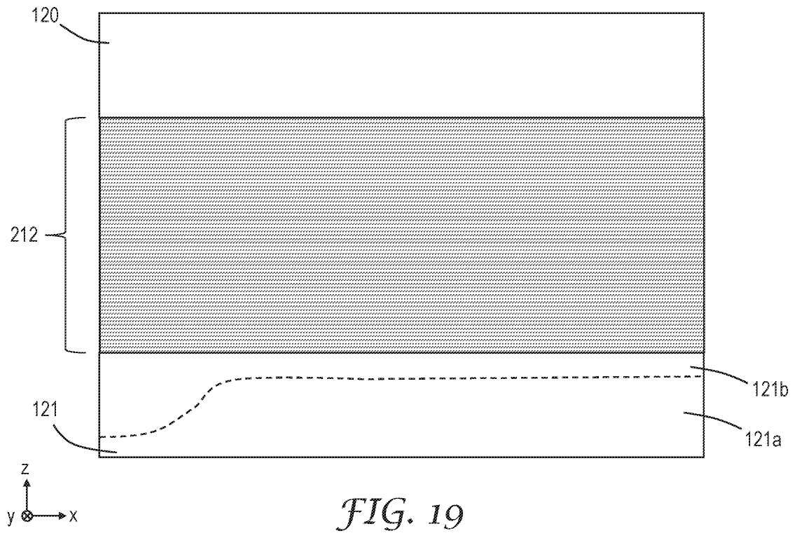

Other thickness profiles can be generated similarly. FIG. 19 is a schematic cross-sectional view of another film that may be extruded as described for FIGS. 16-17 but with a plate 811 for only one of the skin layers where the plate is configured to produce the illustrated thickness profile for the outer and inner portions 121a and 121b, according to some embodiments. Upon reducing the flow rate to portion 121b while compensating with increased flow rate to the plurality 212 of optical repeat units, the plurality of layers of the optical repeat units become thicker on the left hand side (small values of the x-coordinate) of the film.

### Examples

Optical films were made that included alternating first and second layers disposed between skin layers. The skins were delivered to a die as generally described for FIGS. 16-18. The skin layers included inner skin layers 120b, 121b thicker in the center of the web and thinner in the edges, and outer skin layers 120a, 121a being thinner in the center and thicker on the edges of the film. The inner and outer skin layers were co-polyester terephthalate and co-polyester naphthalate, respectively. The multilayer optical portion 122 of the film stack included a total of 151 layers of alternating co-polyester naphthalate (B layers) and polymethylmethacrylate (A layers). The co-polyester terephthalate was PETg obtained as EASTAR GN071 from Eastman Chemical Company (Kingsport, TN). The co-polyester naphthalate was 0.48 IV (intrinsic viscosity) coPEN 90/10 (90 mol % naphthalate ester moieties, 10 mol % terephthalate ester moieties, 100 mol % ethylene glycol diol moieties) which is sometimes referred to as Low Melt PEN.

The mass flow to the skin layers were varied while the overall film thickness was held approximately constant. The feed rates for Examples 1 and 2 are shown in in the table below. Samples were cut off-center of the cast web as to show one side of the flow induced by the non-planar skins. After cutting, samples were batch stretched 3.5× by 3.5× in a KARO IV (Bruckner Maschinenbua GmbH and Co., Siegsdorf Germany) stretcher. In comparison, a sample was made with conventional flow conditions which resulted in substantially uniform total thickness for the multilayer optical portion 122 while the outer and inner skin layers had variable thicknesses, resulting in a substantially uniform reflectance across the width of the film.

| | Example 1 | Example 2 |
|---|---|---|
| Outer Skin Layers 120a, 121a | 12 | 12 |
| (lb/hr) | | |
| Inner Skin Layers 120b, 121b | 2 | 4 |
| (lb/hr) | | |
| A layer (lb/hr) | 11 | 11 |
| B layer (lb/hr) | 8 | 8 |

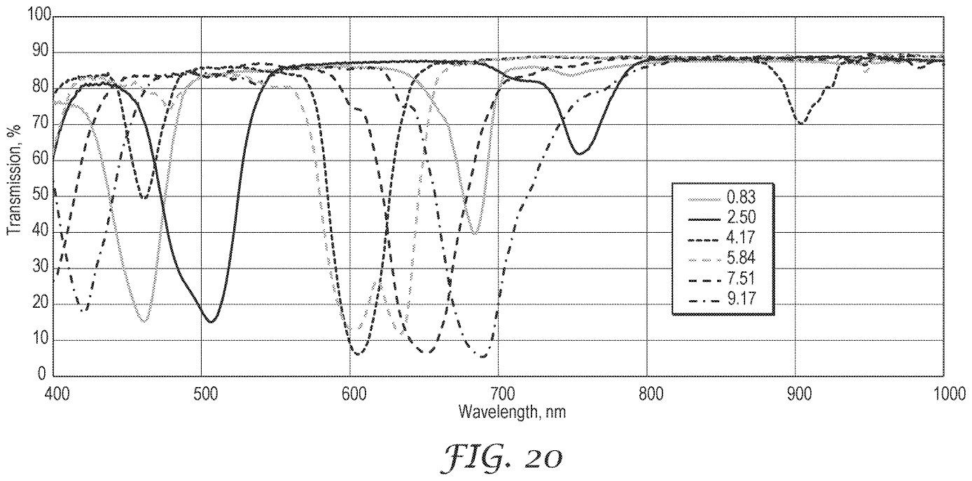

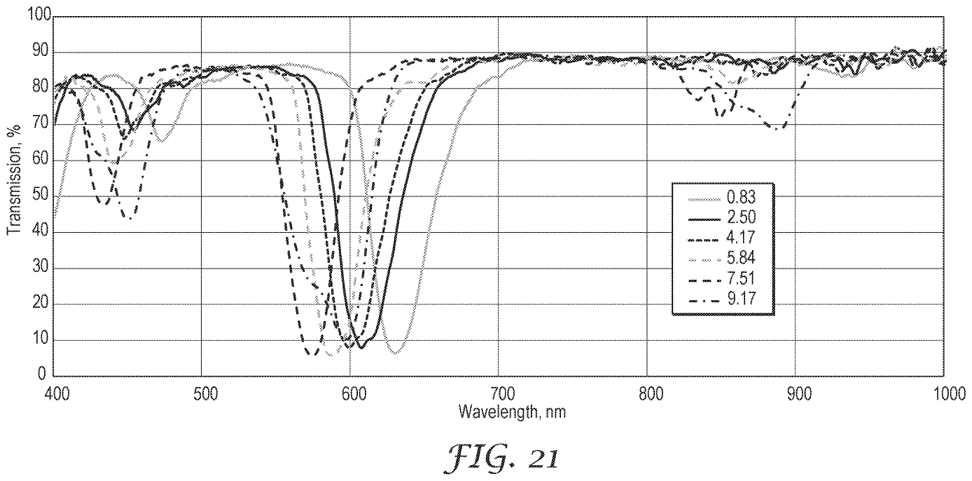

Physical caliper (total thickness) and optical transmission for normally incident light were measured in each sample at different crossweb positions. The reflection spectra measured at different crossweb positions indicated by inches (e.g., 0.83 inches, 2.50 inches, etc.) from an edge of the film for Examples 1 and 2 are shown in FIGS. 20 and 21, respectively. The physical caliper had a coefficient of variation (standard deviation divided by mean times 100%) of 6.8% for Example 1 and 4.9% for Example 2. The change in the reflection band between Examples 1 and 2 shows how the varied feed rate in the inner, non-planar skin changed the reflected wavelengths of the film cross web with minimal effect to the overall crossweb caliper. The location of the reflection band was characterized by the wavelength with the lowest transmission. The coefficient of variation of the reflection band position was 13.6% for Example 1 and 3.3% for Example 2.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. An optical film comprising a plurality of polymeric layers disposed between, and coextruded with, first and second skin layers, each of the polymeric layers having a maximum thickness of less than about 700 nm, each of the first and second skin layers having a maximum thickness of greater than about 500 nm, the first and second skin layers having outermost first major surfaces facing away from each other, the optical film comprising non-overlapping substantially parallel first and second regions extending along a length, and arranged along a width, of the optical film,
each of the polymeric layers and the first and second skin layers extending seamlessly and continuously between and across the first and second regions,
each of the polymeric layers having average thicknesses h1 and h2 in the respective first and second regions, h1 greater than h2 by at least about 5%; and
average separations between the outermost first major surfaces of the first and second skin layers being s1 and s2 in the respective first and second regions, s1 and s2 within less than about 5% of each other.

2. The optical film of claim 1, wherein the first and second skin layers have innermost second major surfaces facing each other, wherein average separations between the innermost major surfaces of the first and second skin layers are t1 and t2 in the respective first and second regions, and wherein t1 is greater than t2 by at least about 5%.

3. The optical film of claim 1, wherein the first and second regions extend substantially along an entire length of the optical film.

4. The optical film of any claim 1 further comprising a third region non-overlapping and substantially parallel with the first and second regions,
each of the polymeric layers and the first and second skin layers extending seamlessly and continuously between and across the first, second, and third regions,
each of the polymeric layers having average thicknesses h1 in the first region and h2 in each of the second and third regions, h1 greater than h2 by at least about 5%; and
average separations between the outermost first major surfaces of the first and second skin layers being s1 in the first region and s2 in each of the second and third regions, s1 and s2 within less than about 5% of each other.

5. An optical construction comprising the optical film of claim 1 bonded to at least one bonding layer.

6. An optical film comprising a plurality of polymeric layers disposed between, and coextruded with, first and second skin layers, each of the polymeric layers having a maximum thickness of less than about 700 nm, each of the first and second skin layers having a maximum thickness of greater than about 500 nm, the first and second skin layers having outermost first major surfaces facing away from each other, the optical film comprising a first region disposed between second and third regions,
each of the polymeric layers and the first and second skin layers extending seamlessly and continuously between and across the first through third regions, maximum separations between the outermost first major surfaces of the first and second skin layers in the first, second, and third regions being within about 10% of each other, such that for a substantially normally incident light, for at least one polarization state, and for first and second wavelengths that are at least 20 nm apart, the optical film has:
for the first wavelength, an optical transmittance of greater than about 50% in each of the first, second and third regions; and
for the second wavelength, an optical transmittance of greater than about 50% in the first region, and an optical transmittance of less than about 20% in each of the second and third regions.

7. The optical film of claim 6, wherein the plurality of polymeric layers in the first, second, and third regions have respective maximum layer thicknesses tm1, tm2, and tm3, and wherein tm1 is greater than each of tm2 and tm3 by at least 2%.

8. The optical film of claim 6, wherein the first wavelength is a visible wavelength in a visible wavelength range extending from about 420 nm to about 680 nm, and the second wavelength is an infrared wavelength in an infrared wavelength range extending from about 700 nm to at least about 1500 nm.

9. An optical film comprising a plurality of polymeric layers disposed between, and coextruded with, first and second skin layers, each of the polymeric layers having a maximum thickness of less than about 700 nm, each of the first and second skin layers having a maximum thickness of greater than about 500 nm, the first and second skin layers having outermost first major surfaces facing away from each other, the optical film comprising non-overlapping substantially parallel first and second regions extending along a length, and arranged along a width, of the optical film,
each of the polymeric layers and the first and second skin layers extending seamlessly and continuously between and across the first and second regions, maximum separations between the outermost first major surfaces of the first and second skin layers in the first and second regions being within about 10% of each other,
total optical thicknesses of the plurality of polymeric layers in the first and second regions sufficiently different from each other so that for a substantially normally incident light, for at least one polarization state, and first and second wavelength ranges, each of the wavelength ranges being at least 20 nm wide, the plurality of polymeric layers has:
an optical transmittance of greater than about 50% for each wavelength in the first wavelength range for the first, but not the second, region; and
an optical transmittance of less than about 40% for each wavelength in the second wavelength range for each of the first and second regions,
wherein the first and second wavelength ranges are less than about 200 nm apart.

10. The optical film of claim 9, wherein the total optical thicknesses of the plurality of polymeric layers in the first and second regions are different from each other by at least about 5%.

11. The optical film of claim 9, wherein the first wavelength range is a visible wavelength range extending from about 420 nm to about 680 nm, and the second wavelength range is an infrared wavelength range extending from about 700 nm to at least about 1000 nm.

12. An optical film comprising a plurality of optical repeat units disposed between, and coextruded with, first and second skin layers, each of the optical repeat units comprising at least two different polymeric layers, each of the polymeric layers in the optical repeat units having a maximum thickness of less than about 700 nm, each of the first and second skin layers having a maximum thickness of greater than about 500 nm, the first and second skin layers having outermost first major surfaces facing away from each other, the optical film comprising non-overlapping substantially parallel first and second regions extending along a length, and arranged along a width, of the optical film, each of the polymeric layers in the optical repeat units and the first and second skin layers extending seamlessly and continuously between and across the first and second regions, maximum separations between the outermost first major surfaces of the first and second skin layers in the first and second regions being within about 10% of each other,
such that for a substantially normally incident light, at least one polarization state, a visible wavelength range extending from about 420 nm to about 680 nm, and a first infrared wavelength that is in an infrared wavelength range extending from about 700 nm to at least about 1500, the plurality of the optical repeat units has:
an average optical transmittance of greater than about 50% in the visible wavelength range for each of the first and second regions; and
for the first infrared wavelength, an optical transmittance of greater than about 50% in the first region and an optical transmittance of less than about 40% in the second region.

13. The optical film of claim 12, wherein the first infrared wavelength is in a range of about 850 nm to about 950 nm.

14. A windshield of a vehicle comprising the optical film of claim 12 disposed between, and bonded to, first and second substrates.

15. An optical sensing system comprising:
the windshield of claim 14; and
a transceiver comprising at least one of a transmitter and a receiver and configured to at least one of emit and receive a first light toward an object through the windshield.

16. A windshield of a vehicle comprising the optical film of claim 1 disposed between, and bonded to, first and second substrates.

17. An optical sensing system comprising:
the windshield of claim 16; and
a transceiver comprising at least one of a transmitter and a receiver and configured to at least one of emit and receive a first light toward an object through the windshield.

18. A windshield of a vehicle comprising the optical film of claim 6 disposed between, and bonded to, first and second substrates.

19. An optical sensing system comprising:
the windshield of claim 18; and
a transceiver comprising at least one of a transmitter and a receiver and configured to at least one of emit and receive a first light toward an object through the windshield.

20. A windshield of a vehicle comprising the optical film of claim 9 disposed between, and bonded to, first and second substrates.
